(19) United States
(12) Patent Application Publication
(10) Pub. No.: US 2023/0221074 A1
(43) Pub. Date: Jul. 13, 2023

(54) APPARATUS FOR DRYING SLUDGE AND METHOD

(71) Applicant: 4 SYMBIOSES INC, Rivière-du-Loup (CA)

(72) Inventors: Gérald PELLETIER, Lac Baker (CA); Jean DESPRÉS, St-Antonin (CA)

(21) Appl. No.: 18/000,736

(22) PCT Filed: Jun. 7, 2021
(86) PCT No.: PCT/CA2021/050777

§ 371 Date: Dec. 5, 2022

Related U.S. Application Data
(60) Provisional application No. 63/035,029, filed on Jun. 5, 2020.

(51) Int. Cl. F26B 17/28; F26B 3/20; F26B 23/06; F26B 25/00; F26B 25/04; B01D 1/22; B01D 1/24; C02F 11/13

(52) U.S. Cl. CPC F26B 17/284; F26B 3/20; F26B 23/06; F26B 25/002; F26B 25/04; B01D 1/225; B01D 1/24; C02F 11/13; F26B 2200/18

(57) ABSTRACT

An apparatus for treating a slurry substance comprising: a support structure; a dryer system including drums rotatably mounted to the structure, the drums arranged on the structure to form a throat therebetween; a drive system to rotate the drums; a heating system for heating an outer cylindrical surface of the drums; and a collecting system under the throat configured to collect the substance. The apparatus further comprises at least one feed conveyor wherein the at least one feed conveyor includes a feed plate directing a substance to the throat; and wherein the heating system includes at least one heating element in the hollow cavity configured to heat a heating fluid received within the drums. The system is further characterized by an embodiment wherein the at least one heating element is an electrically powered resistive element and wherein each of the drums has a plurality of the electrically powered resistive elements, the plurality of the electrically powered resistive elements being circumferentially distributed.

### CROSS-REFERENCE TO RELATED APPLICATION

The present application claims the benefit of U.S. Patent Application No. 63/025,029, filed on Jun. 5, 2020 and incorporated herein by reference.

### FIELD OF THE INVENTION

The present application pertains to an apparatus for drying sludge and like viscous substances and to a method for drying sludge, for example, in the context of waste management, micro-plastic recovery, among others.

### BACKGROUND

In waste management, it is common to have to dispose of viscous substances such as sludge that incorporate a mixture of liquids and solids, for example. In an embodiment, such sludge may have water, and pollutants, solids, mixed up. As water or other liquids represent a sizable portion of the mass of the sludge, it may be desired to dry the sludge so as to separate solids from the liquid. The challenge remains to separate the water from the solids in an ecological manner.

### SUMMARY

In one aspect, there is provided an apparatus for treating a substance comprising: a structure; a dryer system including drums rotatably mounted to the structure, the drums arranged on the structure to form a throat therebetween, a drive system to rotate the drums, and a heating system for heating an outer cylindrical surface of the drums.

Still further in accordance with the aspect, for example, at least one feed conveyor may be configured to feed the substance to the throat.

Still further in accordance with the aspect, for example, each of the drums has a respective one of the feed conveyor.

Still further in accordance with the aspect, for example, the at least one feed conveyor includes a feed plate directing a substance to the throat.

Still further in accordance with the aspect, for example, the feed plate has troughs.

Still further in accordance with the aspect, for example, a sieve may be in the at least one feed conveyor.

Still further in accordance with the aspect, for example, including at least one feed screw may be in the feed conveyor.

Still further in accordance with the aspect, for example, a wiper may be between the feed conveyor and at least one of the drum.

Still further in accordance with the aspect, for example, the heating system includes a hollow cavity in the drums configured to receive a heating fluid.

Still further in accordance with the aspect, for example, the heating system includes at least one heating element in the hollow cavity configured to heat the heating fluid.

Still further in accordance with the aspect, for example, the at least one heating element is at least one electrically powered resistive element.

Still further in accordance with the aspect, for example, each of the drums has a plurality of the electrically powered resistive element, the plurality of the electrically powered resistive element being circumferentially distributed.

Still further in accordance with the aspect, for example, assemblies of brushes and slip rings may be configured to power the plurality of the electrically powered resistive element.

Still further in accordance with the aspect, for example, a hydraulic system may be in fluid communication with the hollow cavity.

Still further in accordance with the aspect, for example, the hydraulic system may include a tank, the tank being located at least partially above a top of the drums.

Still further in accordance with the aspect, for example, the tank is an atmospheric tank.

Still further in accordance with the aspect, for example, the hydraulic system has a conduit network extending from the tank to the drums, the conduit network in fluid communication with a conduit portion of a central shaft of the drums.

Still further in accordance with the aspect, for example, the rotational axis of the drums lie in a common plane, the common plane being generally horizontal.

Still further in accordance with the aspect, for example, a scrubbing member may be adjacent to outer cylindrical surface of at least one of the drum.

Still further in accordance with the aspect, for example, the scrubbing member is located within a 6 o'clock and a 9 o'clock position relative to a clockwise direction of rotation of the drum.

Still further in accordance with the aspect, for example, the drive system includes a chain and sprocket transmission and a motor.

Still further in accordance with the aspect, for example, a collecting system may be under the throat configured to collect the substance.

Still further in accordance with the aspect, for example, the collecting system includes a trough and a conduit at a bottom of the trough.

Still further in accordance with the aspect, for example, a hood unit may be mounted above the dryer system and configured to collect steam and/or emissions from the dryer system.

Still further in accordance with the aspect, for example, the hood unit includes a fan.

Still further in accordance with the aspect, for example, at least one of the drums is mounted to the structure with a translational joint.

Still further in accordance with the aspect, for example, a biasing mechanism may bias the drum mounted to the structure with the translational joint toward another of the drums.

Still further in accordance with the aspect, for example, a controller may be configured to control the heating system and the drive system

In accordance with another aspect, there is provided a method for treating a substance comprising: rotating at least a pair of drums having a throat between the drums; heating an outer cylindrical surface of the drums; feeding a substance in the throat to vaporize at least part of a liquid content in the substance; and collecting solids at a bottom of the throat.

Further in accordance with the other aspect, one of the drums from the pair may be biased toward the other of the drums of the pair.

Still further in accordance with the other aspect, heating the outer cylindrical surface includes operating resistive elements in the drums to heat a heating fluid in the drums.

Still further in accordance with the other aspect, heating the outer cylindrical surface includes heating the outer cylindrical surface to a temperature above a melting point temperature of a solid in the substance.

### BRIEF DESCRIPTION OF THE DRYINGS

Reference is now made to the accompanying figures in which:

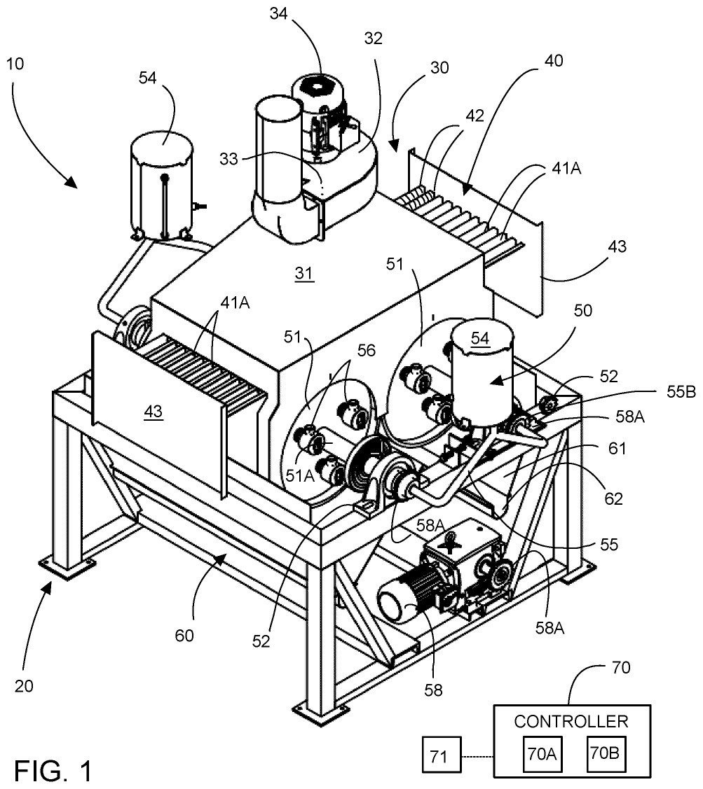

FIG. 1 is an isometric view of an apparatus for drying sludge in accordance with the present disclosure;

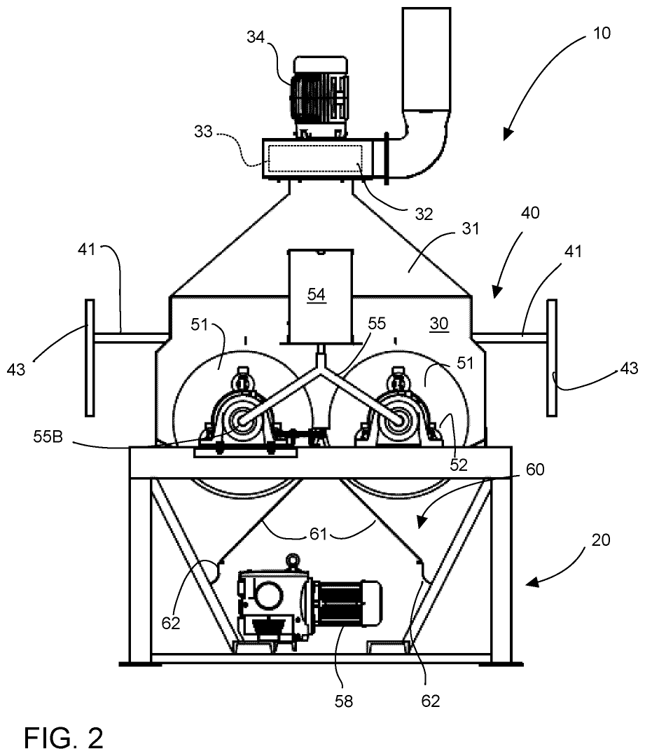

FIG. 2 is an elevation view of the apparatus for drying sludge of FIG. 1;

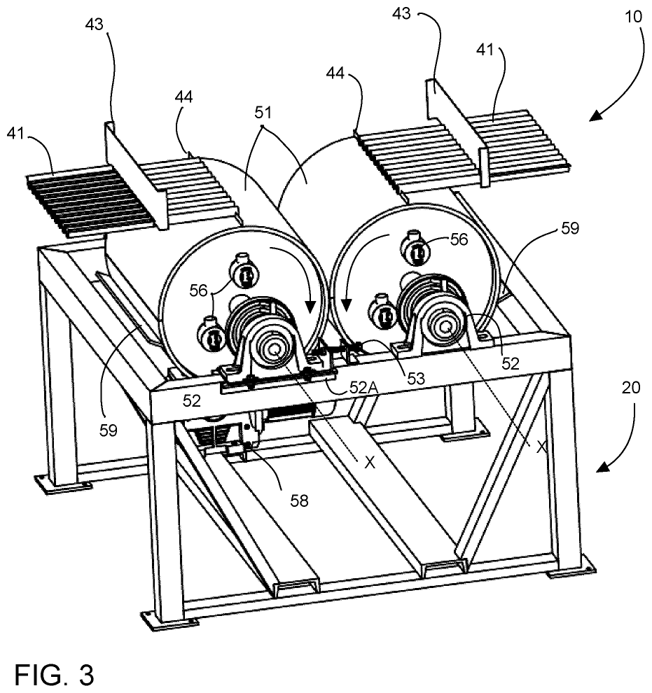

FIG. 3 is a perspective view of the apparatus for drying sludge of FIG. 1, with a hood unit thereof removed;

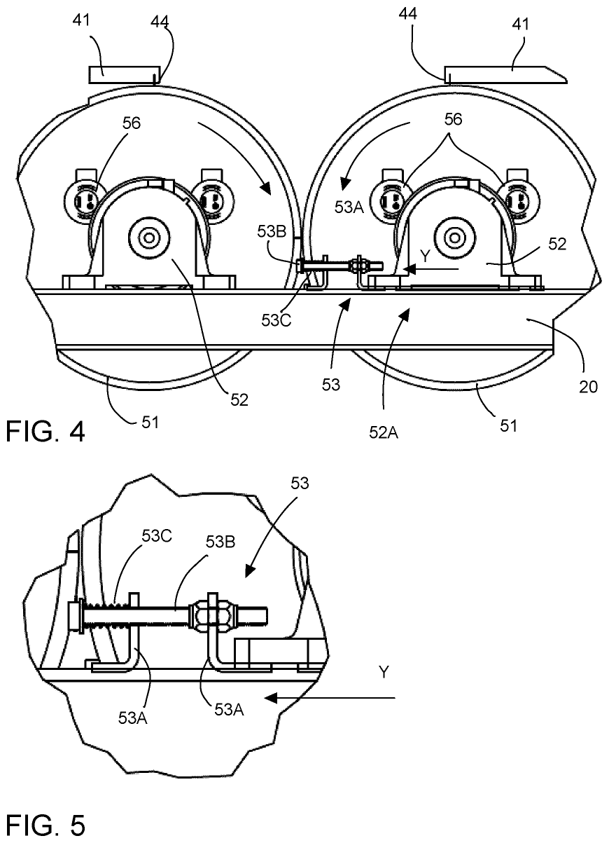

FIG. 4 is an elevation view showing drums of a dryer system of the apparatus of FIG. 1;

FIG. 5 is a detailed view of a translational joint and biasing device of the dryer system of FIG. 4;

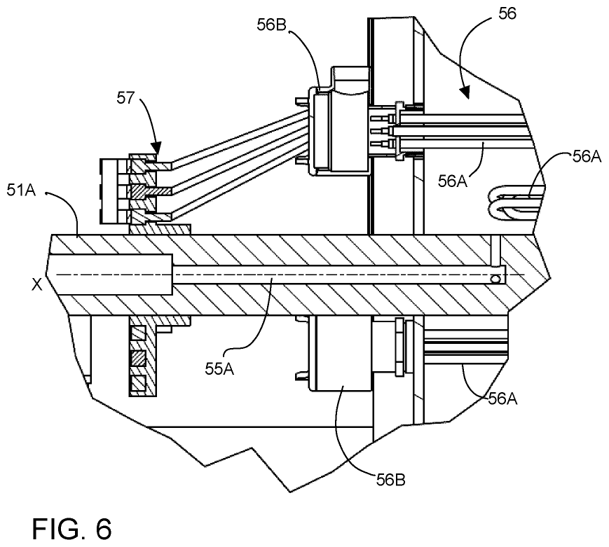

FIG. 6 is a partly sectioned view of an electrical connection of the dryer system of FIG. 4;

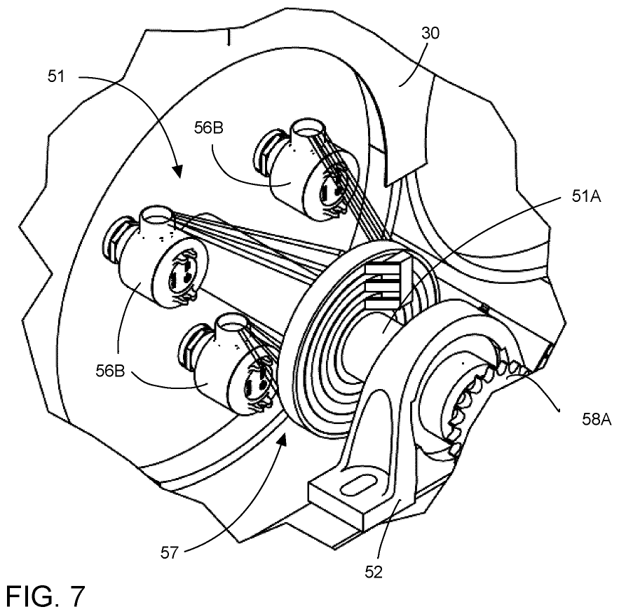

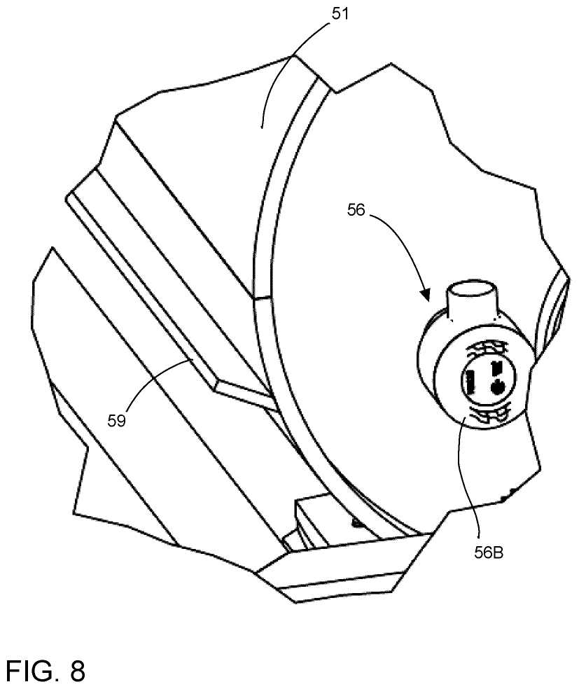

FIG. 7 is a perspective view of the electrical connection of the dryer system of FIG. 5; and

FIG. 8 is an enlarged perspective view of a rake of the dryer system of FIG. 5.

### DESCRIPTION OF THE EMBODIMENTS

Referring to the drawings and more particularly to FIGS. 1-3, an apparatus for drying sludge in accordance with the present disclosure is generally shown at 10. The apparatus for drying sludge will be referred to as apparatus 10 herein for simplicity. The apparatus 10 is said to dry sludge, but it may be used for different applications, such as separating fluids from solids, drying other viscous substances, etc. For example, in a particular embodiment, the apparatus 10 may be used to separate small solid particles, such as micro-plastics, from a state of suspension in the liquid. The apparatus 10 may also sterilize water and/or sterilize solids by exposing bacteria to high process temperatures. However, for simplicity, reference is made herein to the apparatus for drying sludge, though it will be apparent that the apparatus 10 may be used for other purposes as described herein.

The apparatus 10 has one or more of a structure 20, a hood unit 30, a feed conveyor 40, a dryer system 50, a collecting system 60, and/or a controller unit 70, or any combination thereof.
The structure 20 supports the various components of the apparatus 10 may be known as frame, bench, etc.
The hood unit 30 accommodates and covers various operational components of the apparatus 10. The hood unit 30 may be designed to capture emanations and/or vapour/steam from the drying process.
The feed conveyor 40 feeds the substance to be treated to the dryer system 50.
The dryer system 50 separates the liquid content from the solid contents by vaporizing the liquid content.
The collecting system 60 collects the solids at the output of the process.
The controller unit 70 operates the apparatus 10 to effectively control the process.

Referring to FIGS. 1, 2 and 3, the structure 20 is shown as being made of various elongated beams as one possibility. This is an example among others as the structure 20 may have plates, columns, hard surfaces, among various possible structural components. The structure 20 may also be known as a table. The structure 20 is configured to support the various components of the apparatus 10, with the characteristics required for the process described herein to be performed with the apparatus 10, such as structural integrity, temperature and corrosion resistance, etc.

Referring to FIGS. 1 and 2, the hood unit 30 is shown as having a casing 31, which may be optional. The casing 31 is sized so as to accommodate therein an upper portion of the dryer system 50. The casing 31 may for example be made of a sheet metal, among other possible materials. The casing 31 captures gases (e.g., emanations) and vapour (a.k.a., vapor) resulting from the process. At a top end of the casing 31, a ventilation unit may be present so as to assist in exhausting gases and/or vapour (including herein steam) from the apparatus 10. The casing 31 may taper toward an exhaust conduit upon which the ventilation unit is mounted. For example, the ventilation unit may be a centrifugal fan as illustrated. A housing 32 is therefore mounted at an outlet of the casing 31. The ventilation unit may feature a fan 33 inside of the housing, driven by a motor 34. The fan 33 may be a centrifugal fan, as one possibility among others to induce an air flow, with an axial fan and a blower being considered as possibilities among others. In another embodiment, the ventilation unit is part of an adjacent apparatus and is therefore not part of the apparatus 10. Likewise, the hood unit 30 may not necessarily be present as vapour may be captured in other ways, or may be released to ambient depending on the process. For example, a pipe or pipes connected to a vacuum source may be present. Condensing units may be in proximity to the outlet of the casing 31 to liquefy the vapour.

Still referring to FIGS. 1 to 3, the feed conveyor 40 and the dryer system 50 work jointly to dry sludge or like viscous substances, and/or to separate solids from liquids. The feed conveyor 40 and the dryer system 50 may both have a twin configuration based on the fact that a pair of drums are present as described below, though more drums could be present as well, usually in pairs. Therefore, the feed conveyor 40 may have a pair of feed plates 41, as a possibility among others (feed pipe(s), feed channel(s), etc). A single such plate 41 may be present as well. In an embodiment, the feed plates 41 have a plurality of troughs 41A or equivalent channels in which the viscous or liquid substance is conveyed. Alternatively, the plate 41 may be flat, and gravity may assist in directing the substance to the dryer system 50. Feed screws 42, such as motorized feed screws, may be present in the troughs 41A so as to direct the viscous substance inside the hood unit 30, if present, and into the drums of the dryer system 50 as a possibility. The embodiment shown in FIG. 3 is advantageous in that a continuous feed of viscous substance may be fed to the dryer system 50 in a small, steady and/or controlled quantity, in batches, etc. Other types of feed conveyors 40 may be present, as the idea is to feed viscous substance to the dryer system 50, and gravity may be the motive force to control the flow of substance to be treated into the dryer system 50. A wall 43 is shown for each of the feed plates 41. The wall 43 is representative of an apparatus that may contain the viscous substance. For example, the wall 43 is part of a tank. However, the substance to be treated may come through other means, such as a conveyor, pipes, etc. The wall 43 may also contribute to forming a receptacle with the plate 41, for sludge or like substance to accumulate before being fed to the dryer system 50. In the embodiment shown in FIG. 3, the wall 43 may act as a sieve, to reduce the size of substance feed to the dryer system 50, for instance by breaking down lumps into a continuous feed. The wall 43 may therefore define openings opposite the troughs 41A to reduce lump sizes. The presence of the feed screws 42 may assist in the sieving effect, but with other options possible to exert a pressure on the substance upstream of the wall 43 (pressure plate, etc). Consequently, an extrusion-like action may occur at the wall 43, the wall 43 acting as a die.

Referring to FIG. 3, the casing 31 is removed to show an interior of the apparatus 10, with the correlation between the feed conveyor 40 and the dryer system 50 being visible. Wipers 44 may be at a free end of the feed plates 41 so as to ensure that the substance dropping off of the feed conveyor 40 falls into a gap between drums 51 of the dryer system 50. The wipers 44 may be made of a polymeric or metallic material that may withstand temperatures of the process.

Referring to FIGS. 3 and 4, the dryer system 50 is shown in greater detail. The dryer system 50 has a pair of drums 51 that are in an idler configuration, in that they rotate about their axes X, with the axes X being fixed in position relative to the structure 20, though a play may be possible for one or both of the drums 51. Moreover, the axes X may be parallel to one another. The axes X may lie in a common plane, with the plane being for example horizontal (i.e., gravity being normal to the common plane in an embodiment), though other orientations may work. In an embodiment, the drums 51 are hollow and define a receiving cavity, for instance for oil. Other fluids may be in the drums 51, such as coolants, heat transporting fluids, etc. The drums 51 are made of a material that has suitable heat conductivity and structural integrity, such as a metal (e.g., stainless steel, aluminum). The drums 51 are mounted on shafts 51A so as to rotate relative to the structure 20. A pair of supports 52, such as pillow blocks, are therefore provided to rotatingly support each of the drums 51. The pillow blocks 52 are one contemplate solution to support the drums 51, with other types of bearings and supports being possible embodiments. The drums 51 are in close proximity to one another so as to form a throat in which the substance will be received. In an embodiment, the drums 51 may be in contact with one another, or may be define a gap. A spacing between the drums 51 may be varied, whereby the pillow blocks 52 supporting one or both of the drums 51 may be mounted to the structure 20 by way of a translational joint 52A.

In an embodiment, the pillow blocks 52 or like support for both drums 51 are mounted to the structure 20 by translational joints 52A, though this is not necessary. As shown as an exemplary embodiment, the translational joint 52A may include a bracket 53A fixed to the structure 20, and another bracket 53A mounted to the structure 20 with a set of guides and slots so as to be displaceable in translation, along direction Y. A biasing device 53 may be present in order to bias the drum 51 toward the other drum 51, along direction Y, by acting on the brackets 53A. For example, the biasing device 53 in an embodiment has the pair of brackets 53A with a bolt 53B and spring 53C therebetween. The bolt 53B may be fixed to one of the brackets 53A, such as by a pair of nuts as shown, and other components such as washers, etc). The bolt 53B and the brackets 53A act as stops to delimit the movement of the drums 51 relative to one another. The spring 53C is compressed between the head of the bolt 53B and one of the brackets 53A as shown, but could be at other locations, such as between the brackets 53A. Other configurations are considered as well. The action of the spring 53C biases the drums 51 toward one another, but with the possibility of the drums 51 distancing from one another against the action of the spring 53C, when a pressure is present between the drums 51. In an embodiment, a set of the translational joint 52A and biasing device 53 is present on each side of the drive system 50, for a mirroring biasing action on both sides of the drum(s) 51. Accordingly, a translational degree of freedom may be provided between the drums 51 as an option. In another embodiment, the plane of the axes X is not horizontal, for gravity to bias a translating one of the drums 51 toward the other drum 51.

In order to perform the drying process, the drums 51 are heated. More particularly, in an embodiment, the outer cylindrical surface of the drums 51 is heated for the substance to be heated by contact with the drums 51. In an embodiment, the outer cylindrical surface is heated by a fluid such as oil that is inside the inner hollow cavity of the drum(s) 51 (one or both drums 51 being heated in the embodiment shown). For simplicity, reference is made herein to oil being the fluid inside the drum 51, but other fluids may be used, as identified above. Moreover, as an alternative to a heated fluid, heating cartridges may be used, which heating cartridges may be heated electrically, for example. As another alternative, gas burners may be provided inside the drums 51, or may be fed by conduits. If heated by oil, the drums 51 are sealed so as to receive the oil. In an embodiment, a hydraulic system is present to ensure that the drum(s) 51 is(are) filled with oil. Referring to FIG. 1, tanks 54 of the hydraulic system are shown along with conduits 55. The hydraulic conduits 55 extend from the tanks 54 and into the drums 51. The hydraulic conduits 55, as shown in FIG. 6, may include a conduit portion 55A in the shafts 51A. In order for the hydraulic system to be passive, i.e., not rely on a pump to ensure that oil is fed to the drums 51, the tanks 54 may be located above a highest point of the drums 51. Pumps may nevertheless be present. Moreover, the presence of the conduit portion 55A in the shafts 51A may facilitate an assembly of the dryer system 50, with the shafts 51A for instance being static, or with appropriate seals being present at a junction 55B between conduits 55 (extending from the tank 54) to the conduit portion 55A of the shaft 51A. The junction 55B may be any appropriate type of coupling between a rotating component and a fixed component. The tank 54 may be atmospheric, which causes oil to flow by gravity into the drums 51, thereby ensuring that the drums 51 have an oil feed. A plug may be present in the drums 51 to assist in the filling of the drums 51. As an alternative to oil, the surfaces of the drums 51 may be resistive surfaces that may generate heat.

Referring to FIG. 6, one of multiple heating elements 56 is shown as extending into the drums 51, though in some embodiments a single heating element 56 may suffice. The heating elements 56 may be circumferentially distributed as shown, but other locations are possible. The heating elements 56 may be electrically powered and may therefore have coils 56A extending into the inner cavity of the drums 51. The coils 56A may be resistive coils. The heating elements 56 must be fed with an electrical current whereby electrical connectors 56B may be located on sides of the drums 51. As the drums 51 rotate, the heating elements 56 rotate along, whereby the electrical feed must be configured accordingly. A brush and disk arrangement (i.e., slip ring) of a power system 57 is shown in FIGS. 6 and 7 for the current to be fed to the heating elements 56. Other arrangements are considered as well.

Referring to FIGS. 2 and 7, in order to drive the rotation of the drums 51, a drive system may be provided. The drive system may include a motor 58 that may be provided as one possibility. The motor 58 is coupled to the drums 51 by way of a transmission 58A. The transmission 58A may be observed by way of the sprockets (FIGS. 1 and 7) to which is connected an appropriate chain. In an embodiment, a single motor 58 is present so as to ensure that the drums 51 rotate at constant relative speed ratios. Other transmission types may include gear boxes, pulleys and belts, etc. In the illustrated embodiment, both drums 51 are shown as having sprockets 58A and may thus be driven. It is however considered to have a single one of the drums 51 be driven, with the other drum 51 being entrained by friction and by the substance between the drums 51. As another possibility, a motive source may cause a driving flow of oil inside the drums 51, causing a rotation.

Referring to FIG. 8, a scrubbing member such as a rake 59 may be provided for each drum 51. Therefore, substance that may be on the drums 51 may be wiped off by the rake 59. Although the expression “rake” is used, the item 59 may be any appropriate scrubbing member, and may also be known as a wiper, knife, etc. The drums 51 are shown as having cylindrical shapes, but it is possible for an outer surface of the drums 51 not to be cylindrical, and instead have surface features, to increase a heating surface thereof. For example, an outline of the drums 51 may be sinusoidal, as an option among others. The rakes 59 would be shaped correspondingly. In an embodiment, the rakes 59 are located anywhere between a 4 o'clock and a 12 o'clock positon on the drum 51, relative to a clockwise direction of rotation. For example, the drums 51 meet at 3 o'clock. In the embodiment of FIG. 8, the rake 59 is between an 8 o'clock and a 9 o'clock position on the drum 51. In another embodiment, the rake 59 is between the 6 o'clock and the 9 o'clock position.

Referring to FIG. 2, a collecting system 60 may be in the shape of plates forming troughs 61, with optional conduit 62 (the collecting system 60 removed from FIG. 3 for clarity). The collecting system 60 may therefore be located below the drums 51, in register with the throat. The collecting system 60 is therefore passive in that it may collect dried solids (i.e., with reduced liquid content) at the bottom of the dryer system 50. Motorized systems may be present if necessary, to assist in conveying the collected solids or sludge. The collecting system 60 may be part of another apparatus used in conjunction with the apparatus 10.

Now that the apparatus 10 has been described, a method for drying a substance such as a viscous substance, or for separating solids (e.g., plastics, micro-plastics) from a fluid (e.g., water) is described, using for example the apparatus 10. A substance to be treated, including sludge, waste, substances that are liquid with solid particles in suspension, is fed to the dryer system 50. In an embodiment, this is achieved via the feed conveyor 40 that controls a feed of the substance to a throat between the drums 51 of the dryer system 50. The feed may be a continuous feed or in batches, and the volumetric flow may be controlled during the process, for instance by adjusting the speed of the feed screws 42. This may be done by the controller 70.

The dryer system 50 has its drums 51 heated to a temperature specific to the substances to be treated. The drums 51 are rotated, for example in the direction shown in FIG. 4, such that substance dropped into the throat between the drums 51 is directed into the throat, with the assistance of gravity. In an embodiment, the dryer system 50 has the drums 51 at a temperature sufficient to cause vaporization of the water content while not causing combustion or burning of solids in the substance. For example, if the dryer system 50 is to treat water with plastics or microplastics in suspension, the temperature of the drums 51 is such that the contact of the water with liquid will not cause a combustion of the plastics.

The presence of oil in an embodiment is well-suited for a control of the temperature, as the heat capacity of the oil ensures that the outer cylindrical surfaces of the drums 51 is at a relatively constant temperature, taking into consideration the volumetric flow of substance reaching the drums 51. As the substance falling between the drums 51 is heated and exposed to the pressure of the rotating drums 51, it accumulates in the throat and causes the water to boil and evaporate via the hood unit 30, if present. The solid contents are, on the other hand, kept between the drums 51 by gravity. The solid contents are therefore compressed and may consequently gather in a cake. The translating arrangement of the drums 51, if present, may contribute to the compression and throughput, via the biasing action allowing a greater volume of substance to pass, as a function of pressure in the throat. The cake may have a reduced moisture content, in contrast to the sludge that is fed to the drying system 50. By gravity, the solids falls into the collecting system 60 with the rake 59 removing any material gathered onto the surface of the drums 51. In an embodiment, if water is still present in the substance of the collecting system 60, the collected substance may be cycled back to the feed conveyor 40 for another pass. The drums 51 may compact the substance and may consequently squeeze out additional liquids.

The apparatus 10 and the method related to the apparatus 10 may be said to be continuous, in that the substance to be treated is continuously fed to the system, though batch operation, semi-continuous operation are possible. The controller 70 may operate the apparatus 10 and/or perform a method for treating or drying a substance in an automated way. The controller 70 may have one or more processors of a processing unit 70A, and a non-transitory computer-readable memory 70B communicatively coupled to the processing unit and comprising computer-readable program instructions executable by the processing unit. Sensors 71 of various kinds may be provided to monitor the process. For example, temperature sensors (e.g., thermocouples) may be present to monitor drum temperature, substance temperature at the outset. Hygrometers may be used downstream of the drums 51, so as to measure the moisture content in the matter exiting the drying system 50. Force sensors may monitor the pressure on the drums (e.g., via the translational joints 52A for example). The controller 70 may consequently control the speed of rotation of the drums 51, and adjust the feed of substance via the feed conveyor 40. The controller 70 may also control and adjust the temperature in the drums 51 depending on the process. For example, if the substance to be treated is water with micro-plastics, the temperature of the drums 51 may be set to be above a melting point of the plastic. Moreover, the temperature may be in proximity to but below a combustion temperature of the plastic. As a result, the plastic in the water may begin melting and may adhere to the surface of the drums 51, while the water vaporizes. The controller 70 may control speed of rotation as a function of temperature and throughput. For example, an aim of the controller 70 may be keep the speed of rotation as high as possible to maintain a high throughput, and this may require maintain the temperature high as well. However, the controller 70 may keep the temperature below given thresholds to limit the emission of fumes by the dryer system 50.

The apparatus 10 may be described as being for treating a substance and may have a structure; a dryer system including drums rotatably mounted to the structure, the drums arranged on the structure to form a throat therebetween, means to rotate the drums, and a heating system for heating an outer cylindrical surface of the drums; and a feed conveyor configured to feed the substance to the throat.

The apparatus 10 may alternatively be described as being for treating a substance (e.g., being a mixture of substances, a sludge, a liquid with solids in suspension), the apparatus 10 including among other components a structure; a dryer system including drums rotatably mounted to the structure, the drums arranged on the structure to form a throat therebetween, a drive system to rotate the drums, and a heating system for heating an outer cylindrical surface of the drums.

The method described herein may be for treating a substance comprising: rotating at least a pair of drums having a throat between the drums; heating an outer cylindrical surface of the drums; feeding a substance in the throat to vaporize at least part of a liquid content in the substance; and collecting solids at a bottom of the throat.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. An apparatus for treating a substance comprising:
a structure;
a dryer system including
drums rotatably mounted to the structure, the drums arranged on the structure to form a throat therebetween,
a drive system to rotate the drums, and
a heating system for heating an outer cylindrical surface of the drums.

2. The apparatus according to claim 1, including at least one feed conveyor configured to feed the substance to the throat.

3. The apparatus according to claim 2, wherein each of the drums has a respective one of the feed conveyor.

4. The apparatus according to claim 2, wherein the at least one feed conveyor includes a feed plate directing a substance to the throat.

5. (canceled)

6. The apparatus according to claim 2, including a sieve in the at least one feed conveyor.

7. The apparatus according to claim 2, including at least one feed screw in the feed conveyor.

8. The apparatus according to claim 2, including a wiper between the feed conveyor and at least one of the drum.

9. The apparatus according to claim 1, wherein the heating system includes a hollow cavity in the drums configured to receive a heating fluid.

10. The apparatus according to claim 9, wherein the heating system includes at least one heating element in the hollow cavity configured to heat the heating fluid.

11. (canceled)

12. (canceled)

13. The apparatus according to claim 11, including assemblies of brushes and slip rings configured to power the plurality of the electrically powered resistive element.

14. The apparatus according to claim 9, including a hydraulic system in fluid communication with the hollow cavity.

15. The apparatus according to claim 14, wherein the hydraulic system includes a tank, the tank being located at least partially above a top of the drums.

16. (canceled)

17. The apparatus according to claim 15, wherein the hydraulic system has a conduit network extending from the tank to the drums, the conduit network in fluid communication with a conduit portion of a central shaft of the drums.

18. The apparatus according to claim 1, wherein the rotational axis of the drums lie in a common plane, the common plane being generally horizontal.

19. The apparatus according to claim 1, including a scrubbing member adjacent to outer cylindrical surface of at least one of the drum.

20. The apparatus according to claim 19, wherein the scrubbing member is located within a 6 o'clock and a 9 o'clock position relative to a clockwise direction of rotation of the drum.

21. (canceled)

22. The apparatus according to claim 1, including a collecting system under the throat configured to collect the substance.

23. (canceled)

24. The apparatus according to claim 1, including a hood unit mounted above the dryer system and configured to collect steam and/or emissions from the dryer system.

25. (canceled)

26. The apparatus according to claim 1, wherein at least one of the drums is mounted to the structure with a translational joint.

27. The apparatus according to claim 26, including a biasing mechanism to bias the drum mounted to the structure with the translational joint toward another of the drums.

28.-32. (canceled)
